(19) United States
(12) Patent Application Publication
(10) Pub. No.: US 2010/0084243 A1
(43) Pub. Date: Apr. 8, 2010

(54) USE OF A BRAKE

(75) Inventors: Erich Köhl, Meerbusch (DE); August van der Beek, Grevenbroich (DE)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Metso Lindemann GmbH

(21) Appl. No.: 12/557,594

(22) Filed: Sep. 11, 2009

(30) Foreign Application Priority Data
Oct. 3, 2008 (DE) 10 2008 049 897.1

(51) Int. Cl. F16D 67/00; F16D 27/00

(52) U.S. Cl. 192/226; 192/21.5

(57) ABSTRACT

The invention relates to the use of an electric, hydrodynamic or electromagnetic brake for reducing the rotational speed of a drive-side shaft of a gear mechanism.

### FIELD OF THE INVENTION

The invention relates to the use of an electric, hydrodynamic or electromagnetic brake.

### BACKGROUND OF THE INVENTION

Industrial comminution machines, such as a hammer mill (hammer crusher), have a rotor which is operated at high speed of revolution. The rotor comprises, for example, high-mass tools rotating on a shaft.

The comminution machine is driven, for example, via a motor, the drive-side shaft of which runs to a coupling and, from there, into a gear mechanism in which the drive energy is transmitted to an output-side shaft which is part of the rotor of the comminution machine.

The high inertia of the rotor means that it takes a lot of time to reduce the rotational speed of the work machine, if appropriate down to zero.

In a hammer mill, such as is used for the comminution of industrial waste, having a rotor mass of, for example, 20,000 to 100,000 kg, the run-down time, which is required in order to reduce the speed of revolution from, for example, 600 rpm to zero, may be 30 minutes and more.

It is readily apparent that run-down times of this type have an adverse effect on the production capacity of the work machine.

DE 199 11 772 C2 has proposed braking the rotor by means of a hydraulic arrangement, this arrangement being mechanically coupled to the shaft of the rotor.

This type of braking is, firstly, complex in its design and has the drawback of high frictional heat. In addition, the braking time cannot be reduced to the desired extent.

### SUMMARY OF THE INVENTION

The invention is based on the object of disclosing a possibility of reducing the rotational speed of a comminution machine having a high-mass rotor in as short a time as possible, preferably to zero.

In order to achieve this object, the invention is based on the following consideration: The basic construction of a work machine having an associated drive machine, as presented hereinbefore, has proven successful and may also be maintained.

Mechanical braking means cease to function owing to the high frictional heat and correspondingly high wear.

However, there are also braking means which act in a targeted manner on the drive-side gear shaft, but are substantially wear-free and low-friction and also have a high braking effect.

These include electric, hydrodynamic and electromagnetic brakes. The group of electric brakes includes what is known as the eddy-current brake. This is a contactlessly operating electric brake which converts mechanical energy into heat through eddy-currents in a metallic mass. The eddy-current brake is an internal pole-type DC machine. A stationary inner ring carries a coil through which direct current flows and which generates a homopolar magnetic field. An armature ring made of electrically conductive material, for example iron, forms the active part of the rotor. As the rotor rotates relative to the stator, eddy-currents, which produce together with the stator field a braking moment, the extent of which is dependent on the exciting current and the slip speed, are induced in the armature ring.

The group of hydrodynamic brakes includes what is known as the flow brake, also known as a turbo brake or retarder. The retarder converts the energy to be braked not into heat via solid-to-solid friction, but into kinetic energy of a liquid (in a first stage) and then into heat. The retarder consists of a rotor, which is provided with blades, and a stator in an associated housing. During the braking process, the housing is filled with a liquid, for example hydraulic oil. The revolving rotor sets the liquid into motion which is braked at the stationary stator. The braking force can be varied by adjusting the amount of oil. The heated liquid can be cooled via a fan.

Starting from these preliminary considerations, the invention relates, in its most general embodiment, to the use of an electric, hydrodynamic or electromagnetic brake in a specific arrangement, that is to say, between

a coupling arranged downstream of a drive machine and

a gear mechanism associated with the coupling for the transmission of power and moments to a shaft of an industrial comminution machine,

for reducing the rotational speed of a drive-side shaft of the gear mechanism.

The invention therefore manifests itself not only in the selection of a specific brake for the aforementioned purpose of application (work machine, that is to say, a comminution machine), but also in the specific arrangement of the brake.

Functionally, this has the following implications: The motor is switched off for braking the work machine. The coupling, for example a turbo coupling, connected downstream of the motor is subsequently uncoupled in that oil is pumped out. This occurs almost without delay. The drive is thus switched off. No more power is transmitted from the drive machine to the work machine.

At the same time or shortly thereafter, the brake, for example the retarder, is activated in that oil is pumped in. Simultaneously, the hydrodynamic brake acts on the drive-side shaft of the gear mechanism, as a result of which the rotational energy of the rotor, which continues to revolve, of the work machine is correspondingly braked almost without delay.

The braking force/braking effect can be varied by adjusting the amount of oil and the oil pressure.

The brake serves merely to reduce the rotational speed of the rotor shaft; it is neither a holding brake nor a “stop brake.”

According to one embodiment, the arrangement of the brake is provided in such a way that the brake acts on a gear shaft, which is guided through the gear mechanism, on a gear mechanism side opposing the coupling. In other words, the shaft emanating from the drive machine, which shaft is generally guided via a coupling, is guided through the gear mechanism and protrudes beyond the gear mechanism on the opposing side, where the brake is then applied.

This embodiment is expedient, inter alia, for reasons of space and affords, for example, the possibility of coupling the brake to an auxiliary unit which serves now to drive the shaft, on which the brake acts in the event of braking, so that after step-up in the gear mechanism the connected shaft, for example a cardan shaft, of the work machine can be rotated.

This rotation of the shaft of the work machine, and thus ultimately of the rotor of the machine, serves not to place the machine into the normal work mode, but merely for assembly or repair purposes, for example in order to exchange a hammer from the hammer crusher. For this purpose, it is often necessary to displace the rotor through a few angular degrees in order to make the assembly site accessible. This is the purpose of the auxiliary unit which acts indirectly on the drive machine via the brake and can operate at low rotational speed.

Further features of the invention emerge from the features of the sub-claims and also the other application documents. This also includes the subsequent description of an exemplary embodiment which also contains generally valid features. Thus, the machine parts presented based on the exemplary embodiment can, for example, also be used individually or in any desired combinations for carrying out the invention.

### BRIEF DESCRIPTION OF THE DRAWING

The invention may take physical form in certain parts and arrangement of parts, a preferred embodiment of which will be described in detail in the specification and illustrated in the accompanying drawing which form a part hereof, and wherein:

FIG. 1 is a schematic illustration of a brake system illustrating a preferred embodiment of the present invention.

### DETAILED DESCRIPTION OF PREFERRED EMBODIMENT

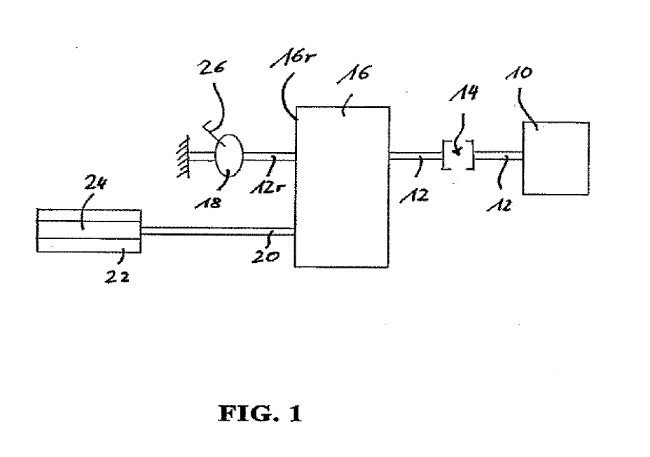

FIG. 1 shows a motor 10 as a drive machine from which a drive shaft 12 extends to a turbo coupling 14 and, from there, to a gear mechanism 16.

The turbo coupling 14 is subject to the principle of the transmission of hydrodynamic force as a result of the interacting of a pump and a turbine. In the case of the turbo coupling, this is achieved by two blade wheels. Together with a housing, the blade wheels form the work space in which the operating liquid, in this case a hydraulic oil, circulates.

The pump wheel is connected to the drive machine, the motor 10, while the turbine wheel is arranged on the side of the coupling that is associated with the gear mechanism 16. The circulating oil transmits the mechanical power from the pump to the turbine. This takes place substantially without wear.

The drive shaft 12 is guided through the gear mechanism 16 and protrudes beyond said gear mechanism on the rear side (back) 16r.

A retarder 18, the design of which has been described hereinbefore, is arranged on this portion 12r of the drive shaft 12 as a hydrodynamic brake.

A stator of the retarder 18 extends on the side remote from the gear mechanism 16; the rotor with the blades extends on the side facing the back 16r of the gear mechanism.

An output shaft 20, which forms a drive shaft for a work machine 22, in this case an industrial hammer crusher with a rotor 24, on which hammer heads are arranged as striking tools, also extends from the gear mechanism 16.

As soon as the motor 10 has been switched off, the coupling 14 opens.

However, owing to the high mass of the rotor 24, the shaft 20, and thus also the part 12r of the drive shaft 12, continues to rotate.

In order to reduce the rotational speed, the retarder 18 is now activated, i.e. filled with oil; the revolving rotor sets in motion the oil which is braked again at the stationary stator and thus has a rotational speed-reducing effect on the shaft 20 which is connected via the gear mechanism 16.

Whereas for a typical application the run-down time of the rotor 24 until stoppage may be of the order of magnitude of 30 minutes and more, it is reduced to approx. 5 minutes as a result of the use and arrangement of a brake according to the invention.

When the rotor 24 stops, it may be necessary, for example for inspection purposes, to rotate the rotor body through a few angular degrees. An auxiliary unit, which is symbolised schematically in the figure by a lever 26, is provided for this purpose. The lever 26 is intended to indicate that, via the auxiliary unit, the portion 12r of the drive shaft 12 is set into rotational motion, via the retarder 18. The rotational energy is transmitted from the gear mechanism 16 to the shaft 20, at low speed of revolution, possibly only through a few angular degrees, in order to bring the rotor 24 into the desired position.

The comminution machine may, for example, be one of the following machines: a hammer mill, rotary shredder, hammer crusher, impact mill, impact crusher.

1. Use of an electric, hydrodynamic or electromagnetic brake between
a) a coupling arranged downstream of a drive machine and
b) a gear mechanism associated with the coupling for the transmission of power and moments to a shaft of an industrial comminution machine,
for reducing the rotational speed of a drive-side shaft of the gear mechanism.

2. Use according to claim 1, with the proviso that the brake is an electric eddy-current brake.

3. Use according to claim 1, with the proviso that the brake is a flow brake.

4. Use according to claim 1, with the proviso that the brake is an electric magnetic brake.

5. Use according to claim 1, with the proviso that the brake acts on a gear shaft, which is guided through the gear mechanism, on a gear mechanism side opposing the coupling.

6. Use according to claim 1, with the proviso that the comminution machine is a machine from the group consisting of a hammer mill, rotary shredder, hammer crusher, impact mill, impact crusher.

7. Use according to claim 1, with the proviso that the brake can be coupled to an auxiliary unit for driving the shaft of the gear mechanism.
